(19) United States
(12) Patent Application Publication
(10) Pub. No.: US 2024/0238669 A1
(43) Pub. Date: Jul. 18, 2024

(54) OPERATION TERMINAL CONTROL DEVICE

(71) Applicant: TOYOTA JIDOSHA KABUSHIKI KAISHA, Toyota-shi (JP)

(72) Inventors: Motohiro KOJIMA, Okazaki-shi (JP); Kuka ISHIYAMA, Musasino-shi (JP)

(73) Assignee: TOYOTA JIDOSHA KABUSHIKI KAISHA, Toyota-shi (JP)

(21) Appl. No.: 18/491,038

(22) Filed: Oct. 20, 2023

(30) Foreign Application Priority Data
Jan. 16, 2023 (JP) 2023-004730

(51) Int. Cl. A63F 13/213; G06F 3/01; G06F 3/0346

(52) U.S. Cl. CPC A63F 13/213; G06F 3/013; G06F 3/0346

(57) ABSTRACT

An angle detection unit for detecting a first angle, which is a relative angle of a display unit capable of displaying an image provided on an operation terminal held by a user, with respect to a first predetermined direction; and when the first angle is not within a first range. and a control unit that limits either or both of an input operation by the user to the input unit provided in the operation terminal and a display operation of the display unit compared to when the first angle is within the first range.

### CROSS-REFERENCE TO RELATED APPLICATION

This application claims priority to Japanese Patent Application No. 2023-004730 filed on Jan. 16, 2023, incorporated herein by reference in its entirety.

### BACKGROUND

### 1. Technical Field

The present disclosure relates to operation terminal control devices.

### 2. Description of Related Art

Japanese Unexamined Patent Application Publication No. 2022-120287 (JP 2022-120287 A) discloses a motion sickness prevention system that includes a terminal and an acquisition device configured to acquire behavior information of a vehicle and display the behavior information of the vehicle acquired by the acquisition device on the screen of the terminal.

### SUMMARY

JP 2022-120287 A has room for improvement in terms of making it less likely for a user who performs either or both of an input operation to the terminal and an action of viewing a display unit to feel discomfort.

In view of the above, it is an object of the present disclosure to provide an operation terminal control device that makes it less likely for a user who performs either or both of an input operation to an operation terminal and an action of viewing a display unit to feel discomfort.

An operation terminal control device of a first aspect includes: an angle detection unit configured to detects a first angle, the first angle being a relative angle of a display unit with respect to a first predetermined direction, the display unit being a display unit of an operation terminal and being configured to display an image, and the operation terminal being able to be held by a user; and a control unit configured to, when the first angle is not within a predetermined first range, limit either or both of an input operation to an input unit of the operation terminal by the user and a display operation of the display unit compared to when the first angle is within the predetermined first range.

In the operation terminal control device of the first aspect, when the first angle is not within the first range, the control unit limits either or both of the input operation to the input unit by the user and the display operation of the display unit compared to when the first angle is within the first range. Therefore, the user is less likely to perform either or both of the input operation to the operation terminal and an action of viewing the display unit when the first angle is not within the first range. Accordingly, the operation terminal control device of the first aspect makes it less likely for the user who performs either or both of the input operation to the operation terminal and the action of viewing the display unit to feel discomfort.

According to an operation terminal control device of a second aspect, in the disclosure according to the first aspect, the display unit may be configured to display a content of a game, and the control unit may be configured to give a point-adding element to the game when the first angle is within the first range.

In the operation terminal control device of the second aspect, the control unit gives the point-adding element to the game when the first angle is within the first range. Therefore, the user is more likely to perform either or both of the input operation to the operation terminal and the action of viewing the display unit while the first angle is within the first range.

According to an operation terminal control device of a third aspect, in the disclosure of the first or second aspect, the display unit may be configured to display a content of a game, and the control unit may be configured to give a point-subtracting element to the game when the first angle is not within the first range.

In the operation terminal control device of the third aspect, the control unit gives the point-subtracting element to the game when the first angle is not within the first range. Therefore, the user is less likely to perform either or both of the input operation to the operation terminal and the action of viewing the display unit while the first angle is not within the first range.

According to an operation terminal control device of a fourth aspect, in the disclosure of the first or second aspect, the display unit may be configured to display a content of a game, and the control unit may be configured to, when the first angle is not within the first range, make the number of point-subtracting elements to be given to the game larger than the number of point-adding elements to be given to the game compared to when the first angle is within the first range.

In the operation terminal control device of the fourth aspect, when the first angle is not within the first range, the control unit makes the number of point-subtracting elements to be given to the game larger than the number of point-adding elements to be given to the game compared to when the first angle is within the first range. Therefore, the user is less likely to perform either or both of the input operation to the operation terminal and the action of viewing the display unit while the first angle is not within the first range.

According to an operation terminal control device of a fifth aspect, in the disclosure of the first or second aspect, the operation terminal control device may further include a gaze detection unit configured to detect a gaze direction of the user, and the control unit may be configured to, when the first angle is not within the first range and a second angle is not within a predetermined second range, limit either or both of the input operation and the display operation of the display unit as compared to when the first angle is within the first range, the second angle being a relative angle of the gaze direction with respect to a second predetermined direction.

In the operation terminal control device of the fifth aspect, when the first angle is not within the first range and the second angle is not within the predetermined second range, the control unit limits either or both of the input operation by the user and the display operation of the display unit compared to when the first angle is within the first range. In other words, when the first angle is not within the first range and the second angle is within the predetermined second range, the control unit does not limit the input operation by the user and the display operation of the display unit. Therefore, the operation terminal control device of the fifth aspect does not limit either or both of the input operation by the user and the display operation of the display unit more than necessary.

As described above, the operation terminal control device according to the present disclosure is very advantageous in that it makes it less likely for a user who performs either or both of the input operation to the operation terminal and the action of viewing the display unit to feel discomfort.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic side view of an occupant holding an operation terminal to which an operation terminal control device according to an embodiment is applied and a part of a vehicle to which the operation terminal control device is applied;

FIG. 2 is a control block diagram of the hardware configuration of the ECU of the vehicle and the operation terminal;

FIG. 3 is a functional block diagram of the ECU;

FIG. 4 is a functional block diagram of the hardware configuration of the operation terminal;

FIG. 5A is a schematic diagram of the display unit when the limiting condition is not satisfied;

FIG. 5B is a schematic diagram of the display unit when the limiting condition is satisfied; and

FIG. 6 is a flowchart showing the processing executed by the CPU of the ECU.

### DETAILED DESCRIPTION OF EMBODIMENTS

Hereinafter, an embodiment of an operation terminal control device 10 (hereinafter referred to as control device 10) according to the present disclosure will be described with reference to the accompanying drawings. The control device 10 of the embodiment is applied to the vehicle 12 and the operation terminal 40. An arrow FR appropriately shown in each drawing indicates the front side of the vehicle, which is the front side in the longitudinal direction of the vehicle, and an arrow UP indicates the upper side of the vehicle, which is the upper side in the vertical direction of the vehicle.

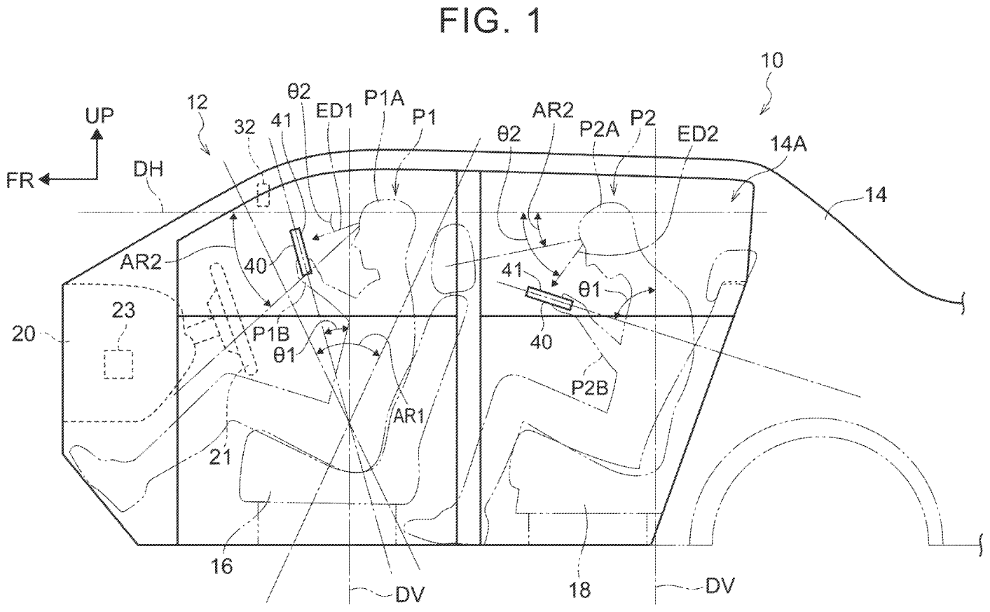

A pair of left and right front seats 16 and a single rear seat 18 are provided in a vehicle cabin 14A, which is an internal space of a vehicle body 14 of the vehicle 12 (only the left front seat 16 is illustrated in FIG. 1). A rear seat 18 is positioned behind the front seat 16. A steering wheel 21 is provided at a portion located to the right of the center in the left-right direction of a dashboard 20 provided at the front end of the vehicle cabin 14A. That is, the front seat 16 on the right side is the driver's seat, and the front seat 16 on the left side is the passenger's seat. As shown in FIG. 1, an occupant (user) P1 is seated in the front seat 16 on the left side, and an occupant (user) P2 is seated in the rear seat 18.

As shown in FIG. 1, the vehicle body 14 is provided with an ECU 23 and a gaze sensor 32.

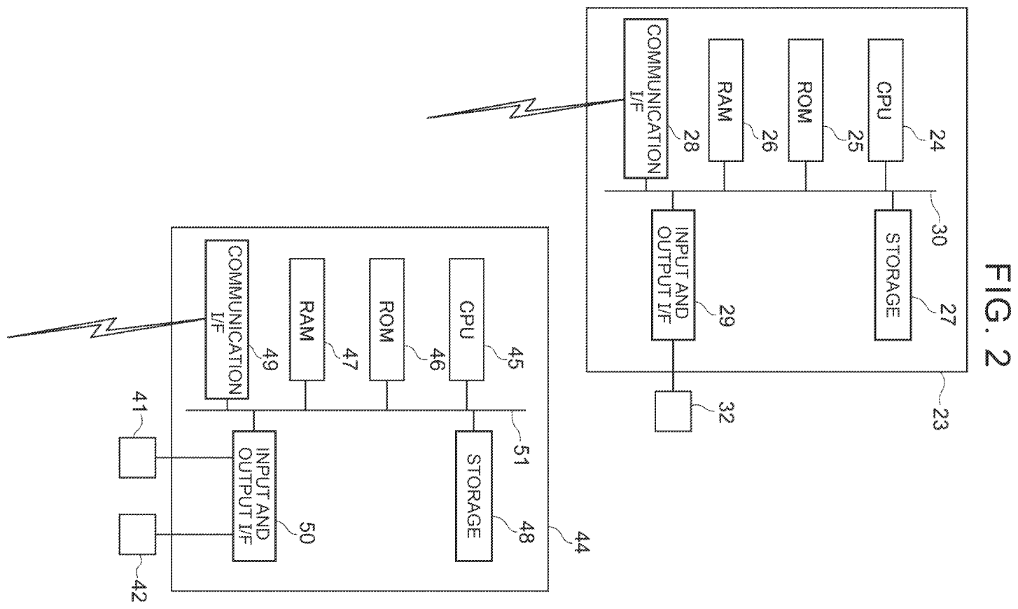

As shown in FIG. 2, the ECU 23 includes a Central Processing Unit (CPU:

processor) 24, a Read Only Memory (ROM) 25, a Random Access Memory (RAM) 26, a storage 27, a communication Interface (I/F) 28 and It is configured including an input/output I/F 29. The CPU 24, ROM 25, RAM 26, storage 27, communication I/F 28 and input/output I/F 29 are connected via a bus 30 so as to be able to communicate with each other. The ECU 23 can acquire information about date and time from a timer (not shown).

The CPU 24 is a central processing unit that executes various programs and controls each unit. That is, the CPU 24 reads a program from the ROM 25 or the storage 27 and executes the program using the RAM 26 as a work area. The CPU 24 performs control of each configuration and various arithmetic processing (information processing) according to programs recorded in the ROM 25 or the storage 27.

The ROM 25 stores various programs and various data. RAM 26 temporarily stores programs or data as a work area. The storage 27 is configured by a storage device such as a Hard Disk Drive (HDD) or Solid State Drive (SSD), and stores various programs and various data. The communication I/F 28 is an interface capable of communicating with devices located outside the vehicle 12. For example, the communication I/F 28 can wirelessly communicate with the communication I/F 49 of the operation terminal 40. The communication I/F 28 uses communication standards such as Bluetooth (registered trademark) and Wi-Fi (registered trademark). Furthermore, the communication I/F 28 can communicate with an ECU other than the ECU 23 provided in the vehicle 12 via an external bus. The input/output I/F 29 is an interface for communicating with various devices.

The gaze sensor 32 is connected to the input/output I/F 29. The gaze sensor 32 of this embodiment includes an infrared illuminator and an infrared camera. The infrared illuminator irradiates the faces P1A and P2A of the occupants P1 and P2 and their surroundings with infrared rays, and the infrared camera captures the faces P1A and P2A of the occupant P1 and P2 and their surroundings.

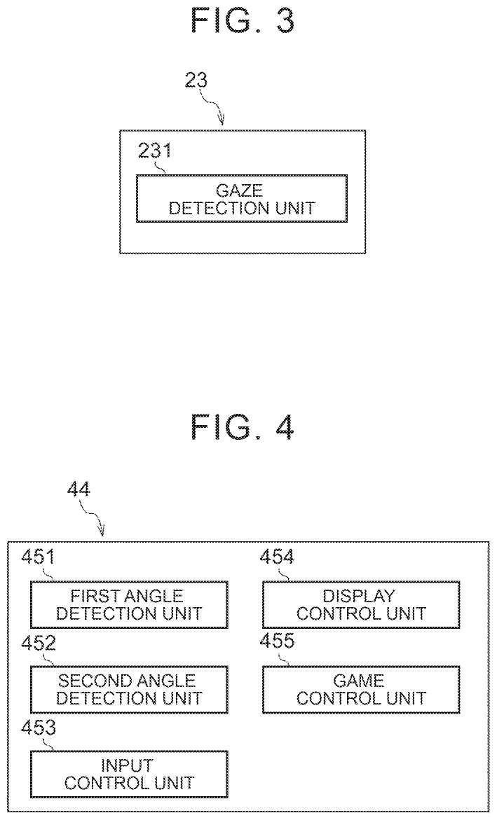

An example of the functional configuration of the ECU 23 is shown in FIG. 3 as a block diagram. The ECU 23 has a gaze detection unit 231 as a functional configuration. Upon receiving subject image data from the gaze sensor 32, the gaze detection unit 231 performs image processing on the subject image data. The gaze detection unit 231 calculates (detects) the directions of the gazes ED1 and ED2 of the occupants P1 and P2 using the methods disclosed in, for example, Japanese Unexamined Patent Application Publication No. 2002-83400 (JP 2002-83400 A) and Japanese Unexamined Patent Application Publication No. H07-61257 (JP H07-61257 A). The communication I/F 28 wirelessly transmits information about the directions of the gazes ED1 and ED2 detected by the gaze detection unit 231 to the communication I/F 49 of the operation terminal 40.

The occupants P1 and P2 hold the operation terminal 40 shown in FIG. 1 with hands P1B and P2B, respectively. The operation terminal 40 of this embodiment is a smart phone. The operation terminal 40 has a flat plate-shaped display unit (input unit) 41 having a touch panel, and a gyro sensor 42 (see FIG. 2). A display unit 41 is provided on the surface of the operation terminal 40. As shown in FIG. 2, the hardware configuration 44 of the operation terminal 40 includes a CPU 45, a ROM 46, a RAM 47, a storage 48, a communication I/F 49 and an input/output I/F 50. The CPU 45, ROM 46, RAM 47, storage 48, communication I/F 49 and input/output I/F 50 are connected via a bus 51 so as to be able to communicate with each other. The functions of the CPU 45, ROM 46, RAM 47, storage 48, communication I/F 49 and input/output I/F 50 are as follows: CPU 24, ROM 25, RAM 26, storage 27, communication I/F 28 and input/output I/F Identical to F 29 respectively. A game application and an anti-motion sickness application are installed in the ROM 46 or storage 48.

An example of the functional configuration of the hardware configuration 44 is shown in FIG. 4 as a block diagram. The hardware configuration 44 includes, as a functional configuration, a first angle detection unit (angle detection unit) 451, a second angle detection unit (angle detection unit) 452, an input control unit (control unit) 453, a display control unit (control unit) 454 and a game control unit (control unit) 455. The first angle detection unit 451, the second angle detection unit 452, the input control unit 453, the display control unit 454, and the game control unit 455 are implemented by the CPU 45 reading and executing programs stored in the ROM 46. Note that the first angle detection unit 451, the second angle detection unit 452, the input control unit 453, and the display control unit 454 function when the anti-motion sickness application is executed.

The first angle detection unit 451 detects a first angle θ1 of the plane surface of the display unit 41 based on the detection value of the gyro sensor 42. As shown in FIG. 1, the angle formed by the vertical direction (first predetermined direction) DV and the surface of the display unit 41 when the operation terminal 40 is viewed from the side is the first angle θ1. Furthermore, the first angle detection unit 451 determines whether the detected first angle θ1 is within a predetermined first range AR1. The first range AR1 of the present embodiment satisfies −α°≤first range AR1≤+α°. Here, the + (plus) angle is the angle forward of the vertical direction DV when the operation terminal 40 is viewed from the side, and the − (minus) angle is the angle behind the vertical direction DV when the operation terminal 40 is viewed from the side. Here, α is an arbitrary value between 20 and 40, for example. Note that α may be any value between 25 and 35. However, α is not limited to this size.

The second angle detection unit 452 detects the second angle θ2 of the occupants P1 and P2 based on the information regarding the directions of the gazes ED1 and ED2 received by the communication I/F 49 from the communication I/F 28 of the vehicle 12. As shown in FIG. 1, the angle between the horizontal direction (second predetermined direction) DH and the gazes ED1 and ED2 when viewed from the side of the vehicle 12 is the second angle θ2. Furthermore, the second angle detection unit 452 determines whether the detected second angle θ2 is within a predetermined second range AR2. The second range AR2 of the present embodiment satisfies 0°≤second range AR2≤+β°. Here, the + (plus) angle is an angle below the horizontal direction DH. Here, β is an arbitrary value between 20 and 40, for example. Note that β may be any value between 25 and 35. However, β is not limited to this size.

The input control unit 453 determines whether a predetermined limiting condition is satisfied. The limiting condition is satisfied when the first angle θ1 is not within the first range AR1 and the second angle θ2 is not within the second range AR2. Furthermore, when it is determined that the limiting condition is satisfied, the input control unit 453 executes limiting control. That is, the input control unit 453 limits input operations to the display unit 41 (touch panel) by the occupants P1 and P2. In this specification, limiting input operations means that all input operations to the display unit 41 are invalidated, or that some input operations to the display unit 41 are invalidated.

When all input operations to the display unit 41 are invalidated, the CPU 45 does not perform arithmetic processing caused by the input operations to the display unit 41. For example, if all input operations to the display unit 41 are disabled while the game application is running on the operation terminal 40, changes caused by the input operations to the display unit 41 do not occur in the running game. Further, when the input operation to the display unit 41 is a character input operation, the input characters are not displayed on the display unit 41 when all the input operations to the display unit 41 are invalidated.

When part of the input operation to the display unit 41 is invalidated, the CPU 45 does not perform arithmetic processing resulting from this part of the input operation. For example, it is assumed that some input operations to the display unit 41 are disabled while the game application is running on the operation terminal 40. In this case, for example, an input operation for giving a game character a predetermined weapon is disabled, while an input operation for giving money to the character is permitted. Further, in this case, for example, while an e-mail transmission operation by inputting to the display unit 41 is disabled, a call operation by inputting to the display unit 41 is permitted.

The display control unit 454 determines whether the limiting condition is satisfied. Furthermore, when it is determined that the limiting condition is satisfied, the display control unit 454 executes limiting control. That is, the display control unit 454 limits the display operation of the display unit 41. In this specification, limiting the display operation means that the display operation of the display unit 41 is entirely disabled or that the display operation of the display unit 41 is partially disabled.

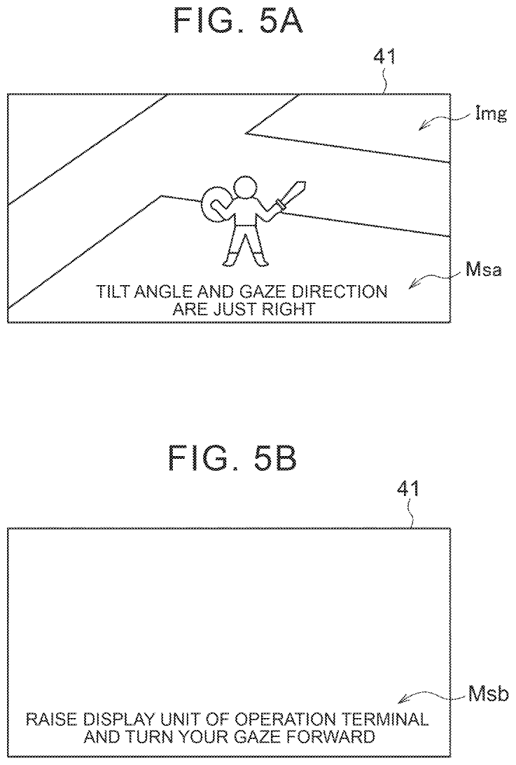

If the limiting condition is not satisfied, the display unit 41 performs normal display operation. For example, when the game application is running on the operation terminal 40, a game image Img as a game content is displayed on the display unit 41 as shown in FIG. 5A.

On the other hand, when all the display operations of the display unit 41 are disabled due to the establishment of the limiting condition, a black or white image is displayed on the entire display unit 41 as shown in FIG. 5B, for example. That is, when the game application is running on the operation terminal 40, the game image Img is not displayed. However, even when all display operations are disabled, a message, which will be described later, may be displayed on the display unit 41.

When the display operation of the display unit 41 is partially disabled, for example, displaying a moving image on the display unit 41 is prohibited, while displaying a still image on the display unit 41 is permitted.

In addition to the limit control, the following message control and point addition/decrease control are executed according to whether the limit condition is satisfied.

Message control is performed as follows. When determining that the limiting condition is satisfied, the display control unit 454 causes the display unit 41 to display a predetermined message. For example, as shown in FIG. 5B, a message Msb is displayed on the display unit 41 that reads, “Raise the display unit of the operation terminal and turn your gaze forward.” Note that the display control unit 454 may cause the display unit 41 to display a message when the time period for which the above limiting condition is satisfied continues for a predetermined time or longer. This predetermined time is, for example, 10 seconds. However, this predetermined time is not limited to this value. Further, when determining that the limiting condition is not satisfied, the display control unit 454 causes the display unit 41 to display a predetermined message. For example, as shown in FIG. 5A, a message Msa is displayed on the display unit 41 stating that “the tilt angle and the gaze direction are just right.” Note that the display control unit 454 may cause the display unit 41 to display a message when the time period in which the limit condition is not satisfied continues for a predetermined time or longer. This predetermined time is, for example, 10 seconds. However, this predetermined time is not limited to this value.

The point addition/decrease control is performed as follows.

The point addition/deduction control is executed while the motion sickness countermeasure application is being executed. Here, it is assumed that the game control unit 455 is executing the process of the game application. For example, when the game control unit 455 determines that the limit condition not satisfied, the game control unit 455 gives a point-adding element to the game and does not give a point-subtracting element described below to the game. Here, the point-adding element is an element that is advantageous for the users (occupants P1 and P2). For example, an element for increasing the physical strength of a game character, an element for giving a character a predetermined weapon, and an element for giving money to a character are point-adding elements. Note that the game control unit 455 may give a point-adding element when the time period in which the limit condition is not satisfied continues for a predetermined time period or longer. This predetermined time is, for example, 10 minutes. However, this predetermined time is not limited to this value.

Further, when the game control unit 455 determines that the limit condition is satisfied, the game control unit 455 gives a point-subtracting element to the game and does not give a point-adding element to the game. Here, the point-subtracting element is a disadvantageous element for the user (occupants P1, P2). For example, an element for reducing the physical strength of a game character, an element for discarding some weapons possessed by the character, and an element for reducing the money possessed by the character are point-subtracting elements. Note that the game control unit 455 may give a point-subtracting element when the time period during which the limit condition is satisfied continues for a predetermined time period or longer. This predetermined time is, for example, 5 minutes. However, this predetermined time is not limited to this value.

### Action and Effect

Next, the operation and effects of the embodiment will be described.

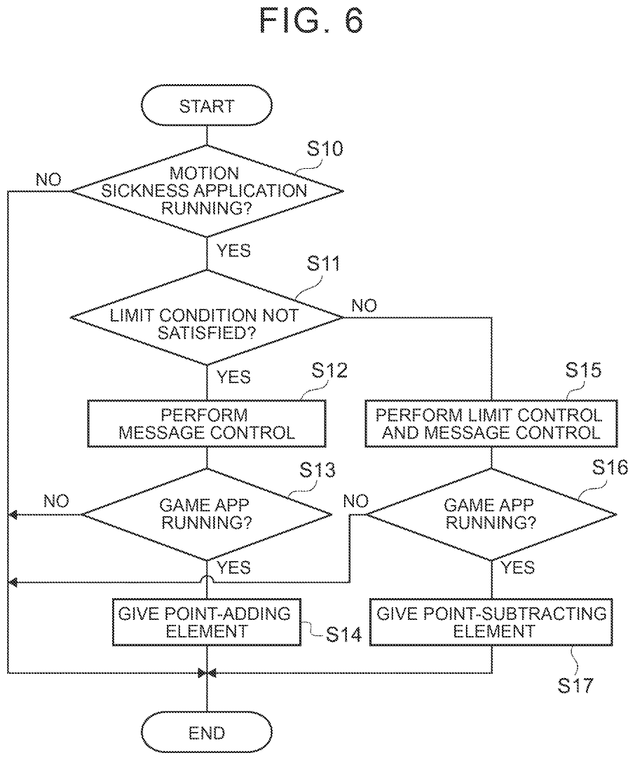

The flow of processing performed by the CPU 45 of the operation terminal 40 will be described below with reference to the flowchart of FIG. 6. The CPU 45 repeatedly executes the processing of the flowchart of FIG. 6 each time a predetermined time elapses. It is assumed that the communication I/F 28 of the ECU 23 and the communication I/F 49 of the operation terminal 40 are performing wireless communication.

First, in S10 (hereinafter, step characters are omitted), the CPU 45 determines whether or not the motion sickness countermeasure application is being executed.

Having determined Yes in S10, the CPU 45 proceeds to S11 and determines whether the limiting condition is satisfied.

If determined as Yes in S11, the CPU 45 proceeds to S12 and executes message control.

After completing the processing of S12, the CPU 45 proceeds to S13 and determines whether the game application is being executed.

When it is determined as Yes in S13, the CPU 45 proceeds to S14 and adds a point-adding element to the game.

On the other hand, if the determination in S11 is No, the CPU 45 proceeds to S15 and executes limit control and message control.

After completing the processing of S15, the CPU 45 proceeds to S16 and determines whether the game application is being executed.

When it is determined as Yes in S16, the CPU 45 proceeds to S17 and gives a point-subtracting element to the game.

When the processing of S14 and S17 is finished, or when the determination is No in S10, 13 and 16, the CPU 45 once ends the processing of the flowchart of FIG. 6.

As described above, the CPU 45 of the control device 10 of the embodiment determines that the limiting conditions are satisfied when the first angle θ1 is not within the first range AR1 and the second angle θ2 is not within the second range AR2. When the limiting condition is satisfied, input operations and display operations on the display unit 41 of the operation terminal 40 by the occupants P1 and P2 are limited compared to when the limiting condition is not satisfied. Therefore, when the first angle θ1 is not within the first range AR1 and the second angle θ2 is not within the second range AR2, the occupants P1 and P2 are less likely to perform an input operation to the operation terminal 40 and an action of viewing the display unit 41.

When the second angle θ2 is not within the second range AR2, the occupants P1 and P2 are less likely to perceive the horizontal direction and recognize their own peripheral information than when the second angle θ2 is within the second range AR2. Therefore, it is difficult for the occupants P1 and P2 to feel the shake based on their vision. On the other hand, the semicircular canals of the occupants P1 and P2 feel the vibration of the vehicle 12. Therefore, when the second angle θ2 is not within the second range AR2, the brains of the occupants P1 and P2 are likely to be confused. Therefore, in the case where the input operation to the operation terminal 40 and the action of viewing the display unit 41 are performed when the second angle θ2 is not within the second range AR2, the occupants P1, P2 are more likely to get motion sickness than in the case where the input operation to the operation terminal 40 and the action of viewing the display unit 41 are performed when the second angle θ2 is within the second range AR2.

On the other hand, in the present embodiment, when the second angle θ2 is not within the second range AR2, the input operation to the display unit 41 of the operation terminal 40 by the occupants P1 and P2 and the display operation of the display unit are limited. That is, when the second angle θ2 is not within the second range AR2, the control device 10 indicates to the occupant P1 the intention to adjust the directions of the gazes ED1 and ED2 so that the second angle θ2 is within the second range AR2. , P2 is easy to hold. Furthermore, in the present embodiment, when the first angle θ1 is not within the first range AR1, the input operation and display operation of the display unit 41 of the operation terminal 40 by the occupants P1 and P2 are limited. That is, when the first angle θ1 is not within the first range AR1, the occupants P1 and P2 are informed of the intention to adjust the first angle θ1 of the operation terminal 40 so that the first angle θ1 is within the first range AR1. Easy to carry. Furthermore, when the first angle θ1 falls within the first range AR1, the second angle θ2 tends to fall within the second range AR2.

Therefore, the control device 10 of the present embodiment makes it less likely for the occupants P1, P2 who perform the input operation to the operation terminal 40 and the action of viewing the display unit 41 to get motion sickness. That is, the control device 10 makes it less likely for the occupants P1, P2 who perform the input operation to the operation terminal 40 and the action of viewing the display unit 41 to feel discomfort. In particular, when either or both of α and β are arbitrary values between 25 and 35, the occupants P1 and P2 are less likely to feel discomfort.

Furthermore, in the present embodiment, limit control is not executed when the first angle θ1 is not within the first range AR1 and the second angle θ2 is within the second range AR2. Therefore, the control device 10 does not limit the input operation to the display unit 41 and the display operation of the display unit 41 by the occupants P1 and P2 more than necessary.

Furthermore, in the present embodiment, a point-adding element is given to the game being executed on the operation terminal 40 when the limiting condition is not satisfied, and a point-subtracting element is given to the game when the limiting condition is satisfied. Therefore, the occupants P1 and P2 are likely to have the intention of performing the operation (game operation) of the operation terminal 40 in a state where the limit condition is not satisfied. Accordingly, in this respect as well, the control device 10 makes it less likely for the occupants P1, P2 who perform the input operation to the operation terminal 40 and the action of viewing the display unit 41 to feel discomfort.

Although the control device 10 according to the embodiment has been described above, the design of the control device 10 can be changed as appropriate without departing from the gist of the present disclosure.

For example, only one of the input operation to the display unit 41 of the operation terminal 40 and the display operation of the display unit 41 may be limited when the limiting condition is satisfied.

When the condition that the first angle θ1 is not within the first range AR1 is satisfied, the limiting condition may be satisfied regardless of the magnitude of the second angle θ2.

When the game application is executed on the operation terminal 40 and the limit condition is satisfied, the point addition/subtraction control is executed such that the number of point-subtracting elements given to the game is greater than the number of point-adding elements given to the game. For example, an element for reducing the physical strength of a game character and an element for discarding some weapons possessed by the character are given to the game as a point-subtracting element, and an element for giving money to the character may be given to the game as a point-adding element.

The gyro sensor 42 may be omitted from the operation terminal 40 and the operation terminal 40 may be photographed by a camera (not shown) provided on the vehicle 12. In this case, the photographed data of the operation terminal 40 acquired by the camera is transmitted from the communication I/F 28 to the communication I/F 49, and the first angle detection unit 451 calculates the first angle θ1 based on this photographed data.

The gaze sensor 32 may be provided on the operation terminal 40 instead of the vehicle 12.

The operation terminal 40 may not be a smart phone. For example, the operation terminal 40 may be a tablet computer or a notebook PC. Further, for example, when the operation terminal 40 is a notebook PC, the input unit may be a keyboard.

What is claimed is:

1. An operation terminal control device, comprising:
an angle detection unit configured to detects a first angle, the first angle being a relative angle of a display unit with respect to a first predetermined direction, the display unit being a display unit of an operation terminal and being configured to display an image, and the operation terminal being able to be held by a user; and
a control unit configured to, when the first angle is not within a predetermined first range, limit either or both of an input operation to an input unit of the operation terminal by the user and a display operation of the display unit compared to when the first angle is within the predetermined first range.

2. The operation terminal control device according to claim 1, wherein
the display unit is configured to display a content of a game, and
the control unit is configured to give a point-adding element to the game when the first angle is within the first range.

3. The operation terminal control device according to claim 1, wherein
the display unit is configured to display a content of a game, and
the control unit is configured to give a point-subtracting element to the game when the first angle is not within the first range.

4. The operation terminal control device according to claim 1, wherein
the display unit is configured to display a content of a game, and
the control unit is configured to, when the first angle is not within the first range, make the number of point-subtracting elements to be given to the game larger than the number of point-adding elements to be given to the game compared to when the first angle is within the first range.

5. The operation terminal control device according to claim 1, further comprising a gaze detection unit configured to detect a gaze direction of the user, wherein the control unit is configured to, when the first angle is not within the first range and a second angle is not within a predetermined second range, limit either or both of the input operation and the display operation of the display unit as compared to when the first angle is within the first range, the second angle being a relative angle of the gaze direction with respect to a second predetermined direction.
